(19) United States
(12) Patent Application Publication
(10) Pub. No.: US 2010/0181357 A1
(43) Pub. Date: Jul. 22, 2010

(54) Collapsible and foldable golf bag carrier for a vehicle

(76) Inventor: Buddy Christianson, Omaha, NE (US)

Correspondence Address: THOMTE LAW OFFICE, L.L.C., 2120 S. 72ND STREET, SUITE 1111, OMAHA, NE, 68124, US

(21) Appl. No.: 12/321,501

(22) Filed: Jan. 22, 2009

(51) Int. Cl. B60R 9/06

(52) U.S. Cl. 224/497; 280/762

(57) ABSTRACT

A collapsible and foldable golf bag carrier which may be collapsed and folded from an operative position to a stowed position for transport. In the operative position, the carrier is mounted at the rear of a vehicle. In the stowed position, the carrier occupies much less space than in its operative position.

### BACKGROUND OF THE INVENTION

1. Field of the Invention

This invention relates to a golf bag carrier for attachment to the rear of a vehicle and more particularly relates to a collapsible and foldable golf bag carrier, which when in its collapsed and folded condition, occupies very little space thereby making it convenient to check the carrier on an airplane or place the same in an overhead bin in the airplane.

2. Description of the Related Art

When golfers travels to golf destinations with their golf bags, it is necessary for them to rent a sufficiently large vehicle which will not only accommodate their suitcases but which will also accommodate one or more golf bags. The need to rent a large vehicle which will accommodate the golfer's suitcases and golf bags greatly increases the automobile rental charges. Further, sufficiently large vehicles are not always available for rental.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

A collapsible and foldable golf bag carrier is described for removable attachment to the rear of a vehicle with the carrier not being dependent upon a vehicle having a hitch at the rearward end thereof. The carrier of this invention includes a generally T-shaped main frame including a generally horizontally disposed first frame member, having first and second ends, and a second frame member extending downwardly therefrom. A selectively adjustable third frame member is slidably received in the lower end of the second frame member and is movable between stowed and operative positions with respect to the second frame member. A golf bag support is operatively pivotally secured to the lower end of the third frame member which is selectively movable from a bag support position to a stowed position. The golf bag support extends generally horizontally rearwardly from the lower end of the third frame member when in its bag supporting position. The bag support extends upwardly from the lower end of the third frame member adjacent the rearward side of the second frame member when in its stowed position.

A first tube is selectively slidably mounted on the first end of the first frame member and is movable between an outer extended position to an inner retracted position. A second tube is selectively slidably mounted on the second end of the first frame member and is movable between an outer extended position and an inner retracted position.

A first elongated cord is secured to the first tube and extends therefrom for attachment to the upper edge of the trunk lid or hatch of the vehicle. A second elongated cord is secured to the second tube and extends therefrom for attachment to the upper edge of the trunk lid or hatch. In the preferred embodiment, the first and second cords are wound upon cord reels positioned within the first and second tubes so that the length of the first and second cords may be selectively adjusted.

A first upper support arm is operatively pivotally secured to the main frame and extends outwardly from the first tube and extends therefrom for selective engagement with the trunk lid or hatch. A second upper support arm is operatively pivotally secured to the main frame within the second tube and extends outwardly therefrom for selective engagement with the trunk lid or hatch. Each of the first and second support arms are selectively movable, with respect to the first and second tubes, between an operative position and a stowed position.

A first lower support arm is secured to the first tube and extends downwardly and forwardly therefrom. A second lower support arm is secured to the second tube and extends downwardly and forwardly therefrom. A first bag retainer is secured to the first lower support arm and which is positioned rearwardly thereof. A second bag retainer is secured to the second lower support arm and which is positioned rearwardly thereof. The first and second upper support arms are closely positioned to the first and second lower support arms when the first and second upper support arms are in their stowed position. The first and second upper support arms are in engagement with the trunk lid or hatch when the carrier is attached to the rear of the vehicle. The first and second lower support arms are in engagement with the rear bumper when the carrier is attached to the rear of the vehicle.

A third elongated cord is secured to the first tube and extends therefrom for attachment to the rear bumper of the vehicle when the carrier is attached to the rear of the vehicle. A fourth elongated cord is secured to the second tube and extends therefrom for attachment to the rear bumper of the vehicle when the carrier is attached to the rear of the vehicle.

The carrier of this invention is foldable and collapsible from an operative position to a stowed position with the carrier occupying considerable less space when in its operative position.

Therefore, it is a principal object of the invention to provide a collapsible and foldable golf bag carrier which is attachable to the rear of a vehicle without the necessity of utilizing a hitch at the rear of the vehicle.

A further object of the invention is to provide a golf bag carrier of the type described which is easily selectively moved between a folded and collapsed position to an operative bag supporting position.

A further object of the invention is to provide a golf bag carrier of the type described which may be adjusted to accommodate different vehicle configurations.

These and other objects will be apparent to those skilled in the art.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a perspective view of the golf bag carrier of this invention in its operative bag supporting position;

FIG. 2 is a perspective view of the bag carrier of this invention in its collapsed and folded position;

FIG. 3 is a side elevational view of a carrier in its operative position with the broken arrow lines indicating various movements of components of the carrier;

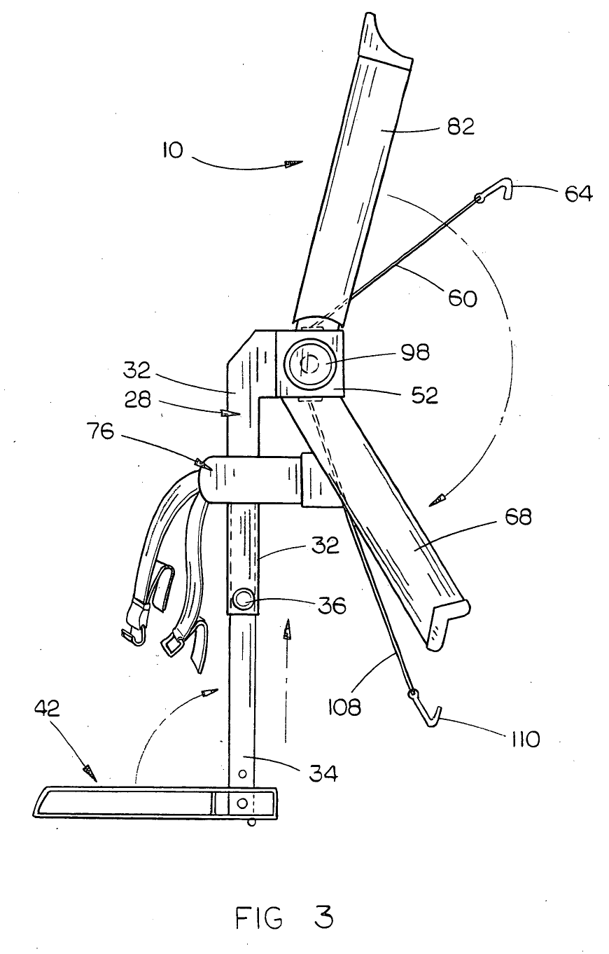

FIG. 4 is a partial sectional view of the means for tightening a pair of upper attachment cords;

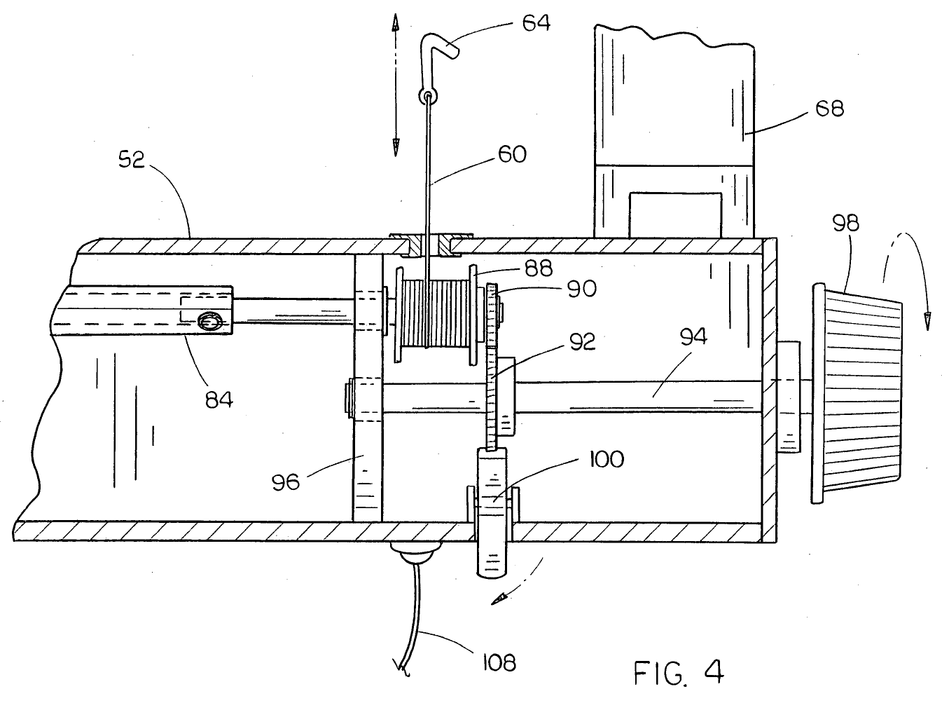

FIG. 5 is a partial perspective view of the positioning means for varying the angular position of the upper support arms;

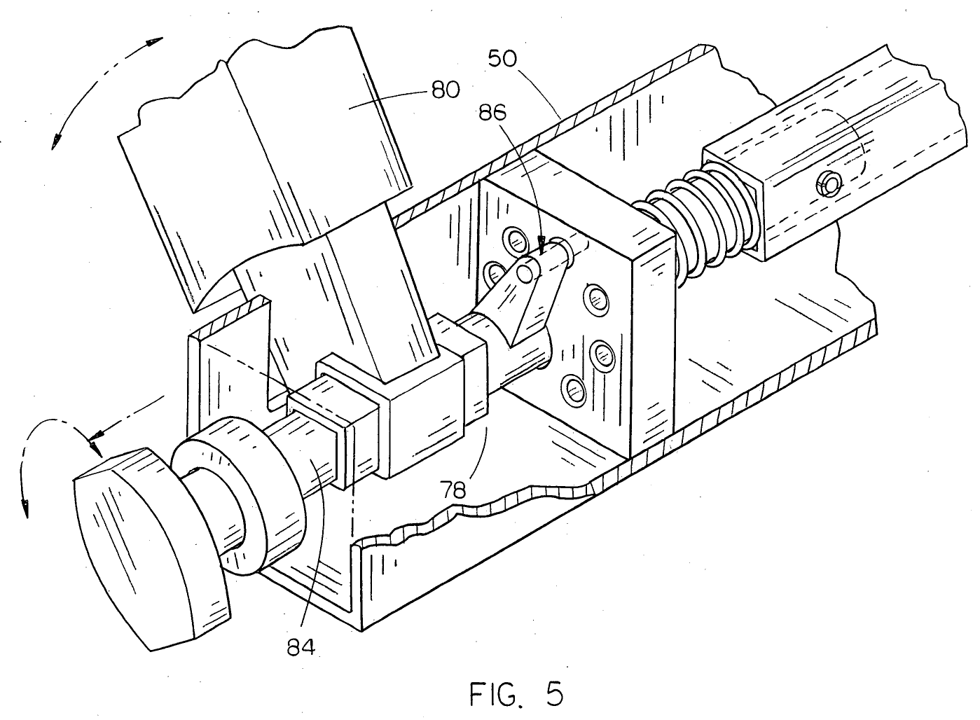

FIG. 6 is a side elevational view illustrating the carrier of this invention secured to the rear of a vehicle and with the bag support being in its stowed position;

FIG. 7 is a side elevational view similar to FIG. 6 except that one or more golf bags are illustrated as being supported on the carrier and with the vehicle being a conventional passenger vehicle; and

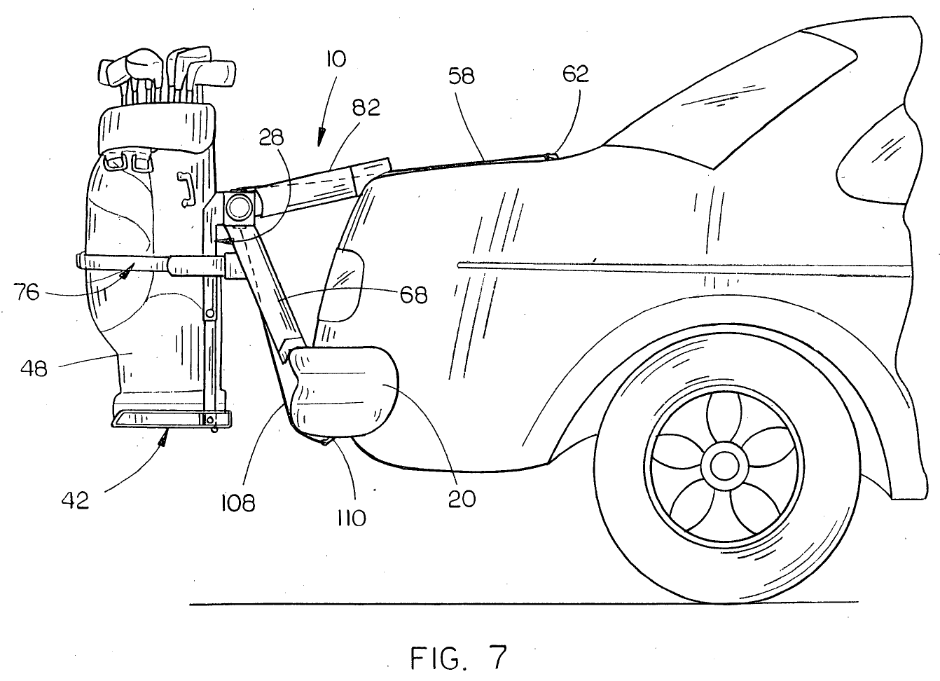

FIG. 8 is a rear perspective view of a bag carrier supporting a pair of golf bags at the rear of a sports utility vehicle having a hatch at the rearward end thereof.

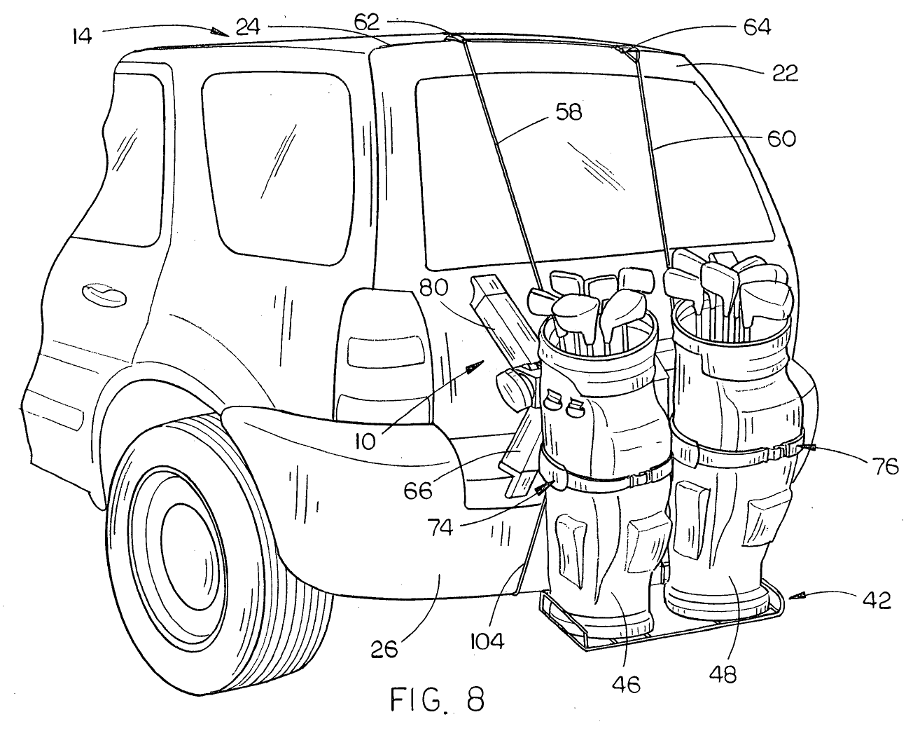

### DESCRIPTION OF THE PREFERRED EMBODIMENT

Embodiments are described more fully below with reference to the accompanying figures, which form a part hereof and show, by way of illustration, specific exemplary embodiments. These embodiments are disclosed in sufficient detail to enable those skilled in the art to practice the invention. However, embodiments may be implemented in many different forms and should not be construed as being limited to the embodiments set forth herein. The following detailed description is, therefore, not to be taken in a limiting sense in that the scope of the present invention is defined only by the appended claims.

The folding golf bag carrier of this invention is referred to by reference numeral 10 and is designed to be attached to the rear of a passenger vehicle 12 or a sports utility vehicle 14. Vehicle 12 includes a trunk lid 16 having an upper edge 18 and a rear bumper 20. Vehicle 14 includes a hatch 22 having an upper edge 24. Vehicle 14 also includes a rear bumper 26.

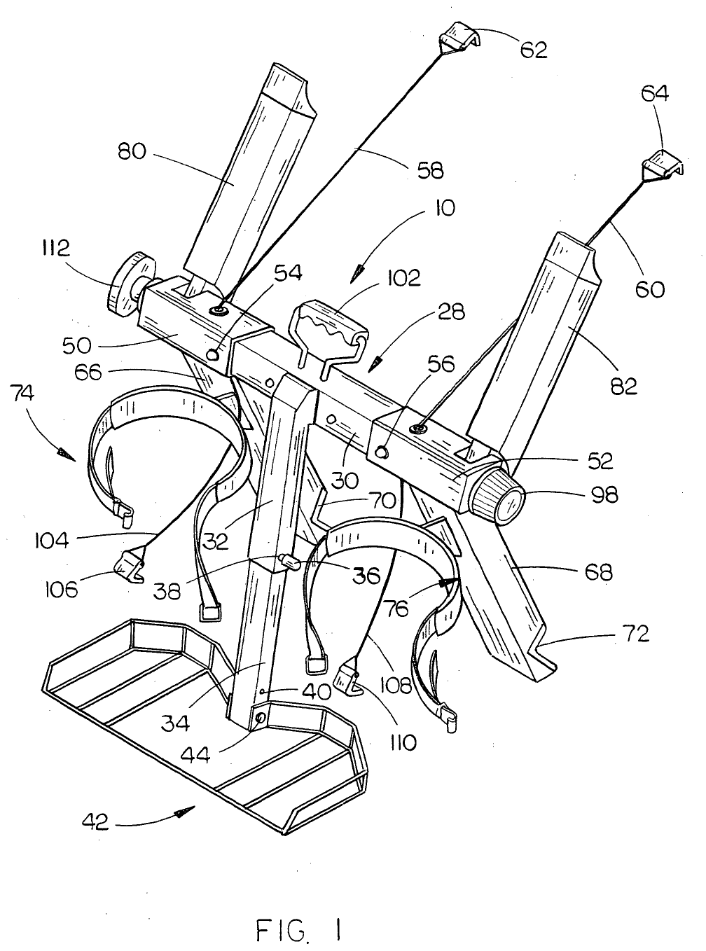

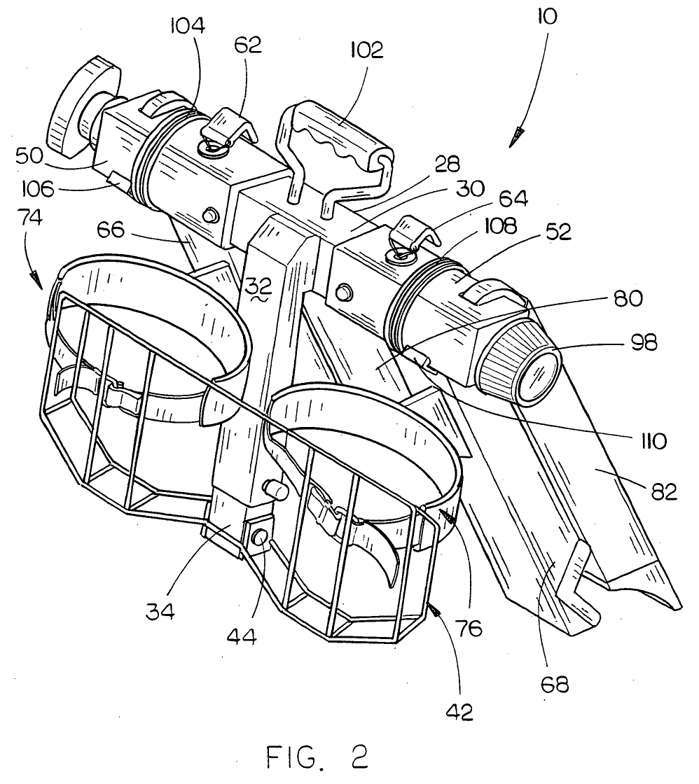

As seen in FIG. 1, carrier 10 includes a T-shaped main frame 28, having a horizontally disposed first frame member or tube 30 and a tube 32 extending downwardly therefrom in transverse manner. Frame member or tube 34 is selectively slidably mounted in frame member 32 and is movable between the extended position of FIG. 1 to the retracted or stowed position of FIG. 2. Pin 36 extends through an opening 38 formed in the lower end of frame member 32 and a registering opening formed in the upper end of frame member 34 to selectively maintain frame member 34 in its extended position. Pin 36 may also be extended into the opening 40 formed in the lower end of frame member 34 to maintain the frame member 34 in its retracted position.

A golf bag support 42 is pivotally movably mounted on the lower end of frame member 34 by pivot pin 44 and is selectively movable between the bag supporting position of FIG. 1 to the folded or stowed position of FIG. 2. Support 42 may be designed to accommodate one or more, preferably two golf bags 46 and 48. Tubes 50 and 52 are selectively slidably mounted on the ends of frame member 30 as seen in FIG. 1 and are selectively movable from the extended position of FIG. 1 to the retracted or stowed position of FIG. 2. Detents 54 and 56 yieldably maintain the tubes 50 and 52 in either their extended or retracted positions. Cords 58 and 60, which are preferably elastic, have their rearward ends movably extending into tubes 50 and 52 as will be explained hereinafter and have clips 62 and 64 secured to their forward ends respectively.

The numerals 66 and 68 refer to lower support arms which have their upper ends welded to tubes 50 and 52 respectively. Preferably, the lower ends of support arms have V-shaped notches 70 and 72 provided thereon respectively. Bag retainer assemblies 74 and 76 are secured to support arms 66 and 68 respectively and are positioned rearwardly thereof so as to be able to be secured to the upper ends of the golf bags.

The number 78 refers to an upper support arm adjustment assembly which is positioned within tube 50, frame member 30 and tube 52. The lower or rearward ends of upper support arms 80 and 82 extend into tubes 50 and 52 and are operatively secured to a rotatable shaft 84 for rotation therewith to enable the angular relationship of the arms 80 and 82 to be adjusted with respect to tubes 50 and 52 respectively to accommodate various vehicle configurations and to permit the support arms to be moved between operative and stowed (folded) positions. Preferably, the outer ends of support arms 80 and 82 are provided with V-shaped notches formed therein. Assembly 78 includes a positioning means 86 to maintain the arms 80 and 82 in their various positions.

A cord reel 88 is freely rotatably mounded on one end of shaft 84 within tube 52 and has cord 60 wrapped therearound. Gear 90 is fixed to reel 88 and is in mesh with a gear or sprocket 92 which is fixed to shaft 94 for rotation therewith. Shaft 94 has one end rotatably supported in support 96 and has its other end rotatably extending outwardly through the end of tube 52. Adjustment knob 98 is mounted on the outer end of shaft 94 for selectively rotating reel 88 to extend or retract cord 60. A ratchet assembly 100 is in engagement with gear or sprocket 92 to permit the cord to be freely wound upon reel 88 while preventing the extension of cord 60 from reel 88 unless the ratchet assembly is depressed. A reel similar to reel 80 is provided within tube 50 at the other end of shaft 84 for cord 58 but does not require a ratchet assembly.

Cord 104 has one end secured to tube 50 and has a clip 106 secured to its other end. Cord 108 has one end secured to tube 52 and has a clip 110 secured to its other end. When not in use, cords 104 and 108 may be wrapped around tubes 50 and 52 respectively as seen in FIG. 2.

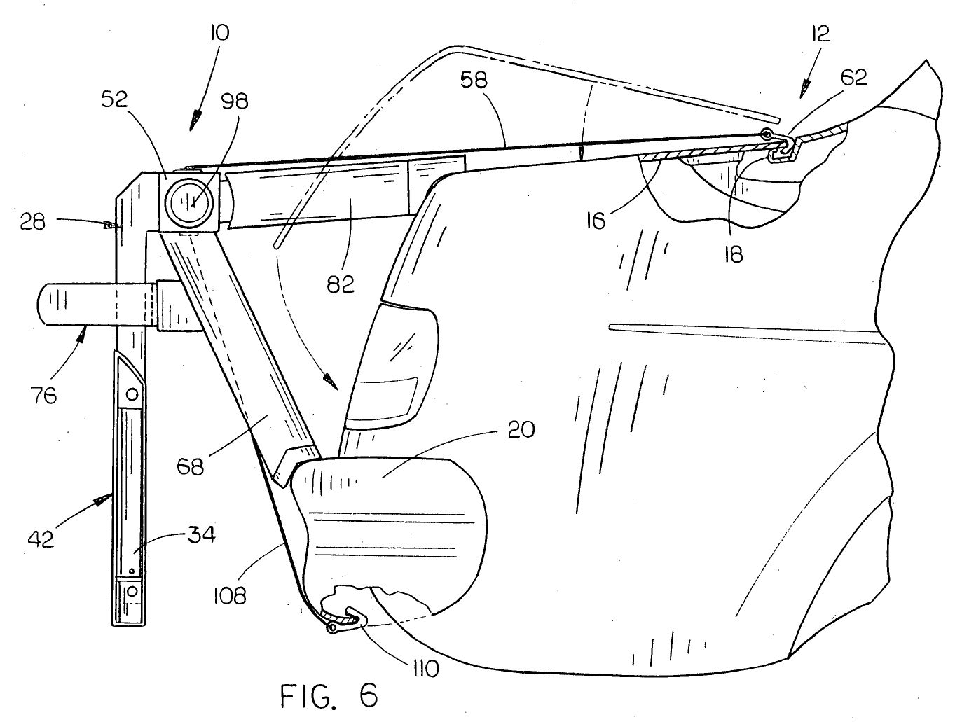

FIG. 1 illustrates the carrier 10 in its operative bag supporting position while FIG. 2 illustrates the carrier 10 in its folded and collapsed position. As seen in FIG. 1, when the carrier 10 is in its operative position, upper support arms 80 and 82 extend upwardly and forwardly with respect to the main frame 28 and lower support arms 66 and 68 extend downwardly and forwardly with respect to main frame 28. Detents 54 and 56 will have been depressed so that tubes 50 and 52 are in their extended positions. As also seen in FIG. 1, bag support 42 has been pivoted to its bag supporting position. The knob 98 is rotated so that the cords 58 and 60 are unwound from cord reel 88 and the cord reel at the other end of shaft 84. Ratchet assembly 100, when freed from engagement with gear 92, permits the cords 58 and 60 to be unwound from their respective reels. The angle of the upper support arms 80 and 82 is adjusted by the positioning means 86 which is controlled by the rotatable knob 112 which may rotate the positioning means 86 and which also may longitudinally move the positioning means 86. The carrier 10 is then positioned at the rear of the vehicle so that the upper support arms 80 and 82 engage the trunk lid 12 or the hatch 22. The lower support arms 66 and 68 are brought into engagement with the rear bumper 20 or 26. Clips 62 and 64 on cords 58 and 60 are attached to the front edge of the trunk lid or hatch. Clips 106 and 110 are then attached to the rear bumper such as illustrated in FIG. 6. The length of the cords 104 and 108 may be adjusted by partially wrapping the same around tubes 50 and 52 respectively. It is also preferred that the cords 104 and 108 be elastic to ensure that the lower support arms 66 and 68 will be drawn tightly into engagement with the rear bumper 20 or 22. Cords 58 and 60 are then tightened by rotating the knob 98. The golf bag or golf bags are then placed on the bag support 42 with the bag retainer assemblies 74 and 76 being wrapped around the golf bags to securely hold the same in position.

When the golfer or golfers arrive at their hotel or the like, the golf bags are removed from the carrier. Cords 56, 60, 104 and 108 are then detached from the vehicle. Cords 58 and 60 are wound upon their respective reels by the knob 98. Cords 104 and 108 are then wrapped around the tubes 50 and 52 respectively. Detents 54 and 56 are operated to permit the tubes 50 and 52 to slidably move inwardly to their retracted stowed positions on frame member 30 (FIG. 2). Knob 112 is then pulled outwardly with respect to main frame 28 and then rotated so that the upper support arms 80 and 82 may be rotated downwardly into close proximity with lower support arms 66 and 68 (FIG. 2). Bag support 42 is then pivoted upwardly to the stowed position of FIG. 2.

Thus it can be seen that the golf bag carrier may be folded and collapsed from its bag carrying position to its travel or stowed position with the folded and collapsed carrier occupying much less space than when in its operative position. In its stowed position, the carrier 10 may be placed in an overhead bin on an airplane or checked as baggage. Upon arrival at their destination, the carrier 10 may be unfolded to its operative position for supporting the golf bags at the rear of even a small vehicle.

Thus, it can be seen that the invention accomplishes at least all of its stated objectives.

Although the invention has been described in language that is specific to certain structures and methodological steps, it is to be understood that the invention defined in the appended claims is not necessarily limited to the specific structures and/or steps described. Rather, the specific aspects and steps are described as forms of implementing the claimed invention. Since many embodiments of the invention can be practiced without departing from the spirit and scope of the invention, the invention resides in the claims hereinafter appended.

1. A folding and collapsible golf bag carrier removably attachable to the rear of a vehicle including a rear bumper, trunk lid or hatch with the trunk lid or hatch having an upper edge, with the carrier not being dependent upon the vehicle having a hitch at the rearward end thereof, comprising:
a generally T-shaped main frame including a generally horizontally disposed first frame member, having first and second ends, and a second frame member extending downwardly therefrom;
said second frame member having a lower end;
a bag support operatively pivotally secured to the lower end of said second frame member which is selectively movable from a bag support position to a stowed position;
said bag support extending generally horizontally rearwardly from said main frame when in its said bag support position;
said bag support extending upwardly from said lower end of said second frame member adjacent said second frame member when in its said stowed position;
a first tube selectively slidably mounted on said first end of said first frame member and being movable between an outer extend position and an inner retracted position;
a second tube selectively slidably mounted on said second end of said first frame member and being movable between an outer extended position and an inner retracted position;
a first elongated cord secured to said first tube and extending therefrom for attachment to the upper edge of the trunk lid or hatch;
a second elongated cord secured to said second tube and extending therefrom for attachment to the upper edge of the trunk lid or hatch;
a first upper support arm operatively pivotably secured to said main frame and extending therefrom for selective engagement with the trunk lid or hatch; a second upper support arm operatively pivotably secured to said main frame and extending therefrom for selective engagement with the trunk lid or hatch;
each of said first and second support arms being selectively movable with respect to said first and second tubes between an operative position to a stowed position;
a first lower support arm secured to said first tube and extending therefrom;
a second lower support arm secured to said second tube and extending therefrom;
a first bag retainer secured to said first lower support arm which is positioned rearwardly thereof;
a second bag retainer secured to said second lower support arm which is positioned rearwardly thereof;
said first and second upper support arms being closely positioned to said first and second lower support arms when said first and second upper support arms are in their said stowed positions;
said first and second upper support arms being in engagement with the trunk lid or hatch when the carrier is attached to the rear of the vehicle;
said first and second lower support arms being in engagement with the rear bumper when the carrier is attached to the rear of the vehicle;
a third elongated cord secured to said first tube and extending therefrom for attachment to the vehicle when the carrier is attached to the rear of the vehicle;
a fourth elongated cord secured to said second tube and extending therefrom for attachment to the vehicle when the carrier is attached to the rear of the vehicle.

2. The carrier of claim 1 further including a carrying handle secured to said main frame.

3. The carrier of claim 1 wherein said third and fourth cords are attached to the rear bumper when the carrier is attached to the rear of the vehicle.

4. The carrier of claim 1 wherein at least some of said cords are elastic.

5. The carrier of claim 1 further including structure for adjusting the length of at least some of said cords.

6. The carrier of claim 1 further including structure for maintaining said first and second upper support arms in various angular positions with respect to said main frame
